(19) United States
(12) Patent Application Publication
(10) Pub. No.: US 2025/0093708 A1
(43) Pub. Date: Mar. 20, 2025

(54) REFLECTING DEVICE

(71) Applicant: Japan Display Inc., Tokyo (JP)

(72) Inventors: Mitsutaka OKITA, Tokyo (JP); Shinichiro OKA, Tokyo (JP); Daiichi SUZUKI, Tokyo (JP)

(73) Assignee: Japan Display Inc., Tokyo (JP)

(21) Appl. No.: 18/964,732

(22) Filed: Dec. 2, 2024

Related U.S. Application Data
(63) Continuation of application No. PCT/JP2023/014623, filed on Apr. 10, 2023.

(30) Foreign Application Priority Data
Jun. 21, 2022 (JP) 2022-099604

(51) Int. Cl. G02F 1/1343

(52) U.S. Cl. CPC G02F 1/134309; G02F 2203/01

(57) ABSTRACT

A reflecting device includes a patch electrode, a common electrode, a liquid crystal layer sandwiched between the patch electrode and the common electrode, and a metal film arranged on the opposite side of the common electrode from the side of the liquid crystal layer, wherein the metal film is spaced apart from the common electrode, and the patch electrode is arranged to overlap the metal film. X can be the value obtained by multiplying a distance T between the common electrode and the metal film by the wavelength λ of the radio wave irradiated to the patch electrode, and x can be equal to or greater than 0.02 and less than or equal to 0.34. X can be equal to or greater than 0.10 and less than or equal to 0.22.

### CROSS-REFERENCE TO RELATED APPLICATIONS

This application is a Continuation of International Patent Application No. PCT/JP2023/014623, filed on Apr. 10, 2023, which claims the benefit of priority to Japanese Patent Application No. 2022-099604, filed on Jun. 21, 2022, the entire contents of each are incorporated herein by reference.

### FIELD

An embodiment of the present invention relates to a reflecting device.

### BACKGROUND

A phase shifter using liquid crystals has been developed for use in phased array antenna devices that can electrically control directivity (For example, refer to Japanese laid-open patent publication No. H11-103201 and 2019-530387).

### SUMMARY

A reflecting device in an embodiment according to the present invention includes a patch electrode, a common electrode, a liquid crystal layer sandwiched between the patch electrode and the common electrode, and a metal film arranged on the opposite side of the common electrode from the side of the liquid crystal layer, wherein the metal film is spaced apart from the common electrode, and the patch electrode is arranged to overlap the metal film.

### BRIEF DESCRIPTION OF DRAWINGS

FIG. 1A is a plan view of a reflector unit cell utilized in a reflecting device according to an embodiment of the present invention.

FIG. 1B shows a cross-sectional structure of a reflector unit cell utilized in a reflecting device according to an embodiment of the present invention.

FIG. 2A is a diagram showing a state in which no voltage is applied between a patch electrode and a common electrode when a reflector unit cell utilized in a reflecting device according to an embodiment of the present invention operates.

FIG. 2B is a diagram showing a state in which a voltage is applied between a patch electrode and a common electrode when a reflector unit cell used in a reflecting device according to an embodiment of the present invention operates.

FIG. 3 shows the measured reflection amplitude versus distance between the common electrode and the metal film of the reflecting device.

FIG. 4 is a cross-sectional structure of a reflector unit cell utilized in a reflecting device according to an embodiment of the present invention.

FIG. 5 is a cross-sectional structure of a reflector unit cell utilized in a reflecting device according to an embodiment of the present invention.

FIG. 6 is a diagram showing a structure of a reflecting device according to an embodiment of the present invention.

FIG. 7 is a schematic diagram showing a change in the traveling direction of a reflected wave by a reflecting device according to an embodiment of the present invention.

FIG. 8 is a diagram showing a structure of a reflecting device according to an embodiment of the present invention

FIG. 9 is a cross-sectional structure of a reflector unit cell in a reflecting device according to an embodiment of the present invention.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but the drawings are only an example and do not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### First Embodiment

### 1. Reflector Unit Cell

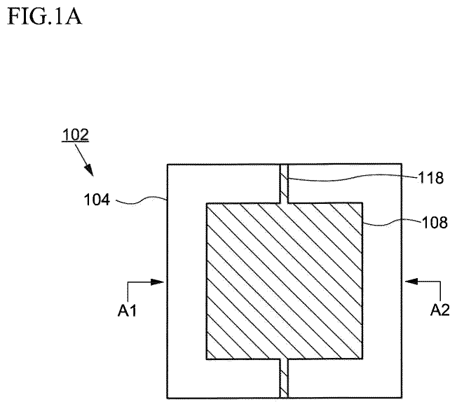

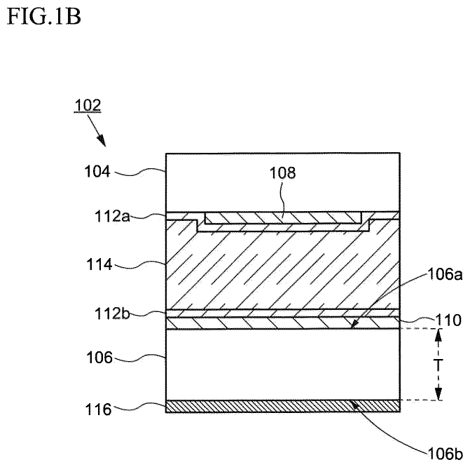

FIG. 1A and FIG. 1B show a reflector unit cell 102 used in a reflecting device according to an embodiment of the present invention. FIG. 1A shows a plan view of the reflector unit cell 102 viewed from above (a side where radio waves enter), and FIG. 1B shows a cross-sectional view between A1-A2 shown in a plan view.

As shown in FIG. 1A and FIG. 1B, the reflector unit cell 102 includes a substrate 104 and a substrate 106, a patch electrode 108, a common electrode 110, a first alignment film 112a, a second alignment film 112b, a liquid crystal layer 114, and a metal film 116. The patch electrode 108 is arranged on the substrate 104, and the common electrode 110 is arranged on the substrate 106. The patch electrode 108 and the common electrode 110 are arranged to face each other, and the liquid crystal layer 114 is sandwiched between the patch electrode 108 and the common electrode 110. The first alignment film 112a is arranged on the substrate 104 between the patch electrode 108 and the liquid crystal layer 114, and the second alignment film 112b is arranged on the substrate 106 between the common electrode 110 and the liquid crystal layer 114.

The substrate 106 has a first surface 106a and a second surface 106b opposite the first surface 106a. The common electrode 110 is arranged on the first surface 106a, and the metal film 116 is arranged on the second surface 106b. The metal film 116 is arranged on the opposite side of the common electrode 110 from the liquid crystal layer 114 side, and is also spaced apart from the common electrode 110. The distance between the first surface 106a and the second surface 106b and/or the distance between the common electrode 110 and the metal film 116 is T. The metal film 116 is arranged to overlap the patch electrode 108 and to have the same or larger area than the common electrode 110.

The patch electrode 108 is preferably symmetrical with respect to the vertical and horizontal polarization of the irradiated radio wave, and has a square or circular shape in a plan view. FIG. 1A shows the case where the patch electrode 108 has a square shape when seen in a plan view. There is no particular limitation to the shape of the common electrode 110 and it may have a shape in which almost the entire surface of the substrate 106 widens to have an area wider than the patch electrode 108. There is no limitation on materials used to form the patch electrode 108 and the common electrode 110, which may be formed using conductive metals and metal oxides.

The substrate 104 may also be disposed with a first wiring 118. The first wiring 118 is directly or electrically connected to the patch electrode 108. The first wiring 118 can be used to apply a control signal to the patch electrode 108. For example, the first wiring 118 can also be used to connect one patch electrode 108 to an adjacent patch electrode 108 when a plurality of reflector unit cells is arranged.

Although not shown in FIG. 1A and FIG. 1B, the substrate 104 and the substrate 106 are bonded together by a sealant. A distance between the substrate 104 and the substrate 106 is 20 to 100 μm, for example, a distance of 50 μm in this case. Since the patch electrode 108, the common electrode 110, the first alignment film 112a, and the second alignment film 112b are disposed between the substrate 104 and the substrate 106, the distance between the first alignment film 112a and the second alignment film 112b disposed on each of the substrate 104 and the substrate 106 is precisely the thickness of the liquid crystal layer 114. Although not shown in FIG. 1B, a spacer may be disposed between the substrate 104 and the substrate 106 to keep the distance constant.

A control signal is applied to the patch electrode 108 to align liquid crystal molecules in the liquid crystal layer 114. The metal electrode 116 is supplied with a potential independent of these signals and is in a floating state. The control signal is a DC voltage signal or a polarity inversion signal in which positive and negative DC voltages are alternately inverted. The common electrode 110 is applied with a voltage at ground or at an intermediate level of the polarity reversal signal. When the control signal is applied to the patch electrode 108, the alignment state of the liquid crystal molecules contained in the liquid crystal layer 114 is changed. Liquid crystal materials having dielectric constant anisotropy are used for the liquid crystal layer 114. For example, nematic, smectic, cholesteric, and discotic liquid crystals are used as the liquid crystal layer 114. The liquid crystal layer 114 with dielectric constant anisotropy has a dielectric constant that changes due to changes in the alignment state of the liquid crystal molecules. The reflector unit cell 102 can change the dielectric constant of the liquid crystal layer 114 by the control signal applied to the patch electrode 108, thereby delaying the phase of the reflected wave when radio waves are reflected.

The frequency bands of radio waves reflected by the reflector unit cell 102 are the very short wave (VHF) band, ultra short wave (UHF) band, microwave (SHF) band, submillimeter wave (THF), and millimeter wave (EHF) band. Although the liquid crystal molecules in the liquid crystal layer 114 align themselves in response to the control signal applied to the patch electrode 108, they hardly follow the frequency of the radio waves irradiated to the patch electrode 108. Therefore, the reflector unit cell 102 can control the phase of the reflected radio waves without being affected by radio waves.

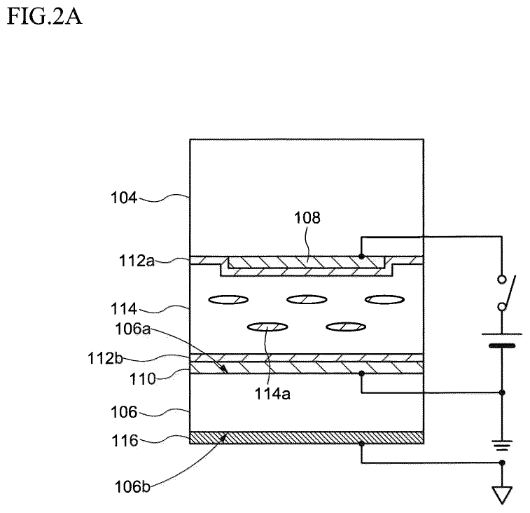

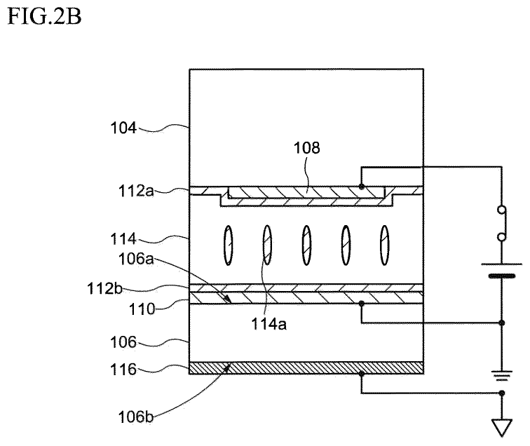

FIG. 2A shows a state (“first state”) in which a voltage is not applied between the patch electrode 108 and the common electrode 110. At this time, the metal film 116 is in a floating state. FIG. 2A shows an example where the first alignment film 112a and the second alignment film 112b are horizontally aligned films. The long axis of the liquid crystal molecules 114a in the first state is aligned horizontally with respect to the surfaces of the patch electrode 108 and the common electrode 110 by the first alignment film 112a and the second alignment film 112b. FIG. 2B shows a state (“second state”) in which a control signal (voltage signal) is applied to the patch electrode 108. Again, the metal film 116 is in a floating state. The liquid crystal molecules 114a are aligned in the second state with the long axis perpendicular to the surfaces of the patch electrode 108 and the common electrode 110 under the effect of the electric field. According to the magnitude of the control signal applied to the patch electrode 108 (magnitude of the voltage between the counter electrode and the patch electrode), it is possible to align the angle at which the long axis of the liquid crystal molecules 114a is aligned in an intermediate direction between the horizontal and vertical directions.

When the liquid crystal molecules 114a have positive dielectric constant anisotropy, the dielectric constant is larger in the second state relative to the first state. When the liquid crystal molecules 114a have negative dielectric constant anisotropy, the dielectric constant is smaller in the second state relative to the first state. The liquid crystal layer 114 having dielectric anisotropy can be regarded as a variable dielectric layer. The reflector unit cell 102 can be controlled to delay (or not) the phase of the reflected wave by using the dielectric constant anisotropy of the liquid crystal layer 114.

The reflector unit cell 102 is used for a reflector that reflects radio waves in a specified direction. The reflector unit cell 102 should have a high amplitude of reflected waves (reflection amplitude) and should completely reflect the radio waves irradiated to the reflector unit cell 102. However, although the common electrode 110 is responsible for reflecting the radio waves irradiated to the patch electrode 108, the common electrode 110 may not completely reflect the irradiated radio waves. Here, the metal film 116 is provided on the opposite side of the common electrode 110 from the liquid crystal layer 114 side, as in the structure shown in FIG. 1B. The metal film 116 is spaced apart from the common electrode 110. By arranging the metal film 116 in this way, radio waves that cannot be reflected by the common electrode 110 can be reflected by the metal film 116. Therefore, the reflector unit cell 102 can expand the amplitude of reflected waves.

Furthermore, as in the structure shown in FIG. 1B, the metal film 116 is spaced a certain distance T away from the opposite side of the common electrode 110 on the liquid crystal layer 114 side. By arranging the metal film 116 in this way, radio waves that cannot be fully reflected by the common electrode 110 can be reflected by the metal film 116. However, since radio waves irradiated to the patch electrode 108 are reflected at the common electrode 110 or the metal film 116, the distance T between the common electrode 110 and the metal film 116 should be considered so that the amplitude of the reflected waves from the radio waves reflected at the common electrode 110 and the metal film 116 is not attenuated. The substrate 106 can be provided between the common electrode 110 and the metal film 116, with the common electrode 110 on one side of the liquid crystal layer 114 and the metal film 116 on the opposite side of the substrate 106. Therefore, the substrate 106 should be considered as shown in FIG. 1B, where the distance T can indicate the thickness of the substrate 106, and the thickness of the substrate 106 should also be considered as described above.

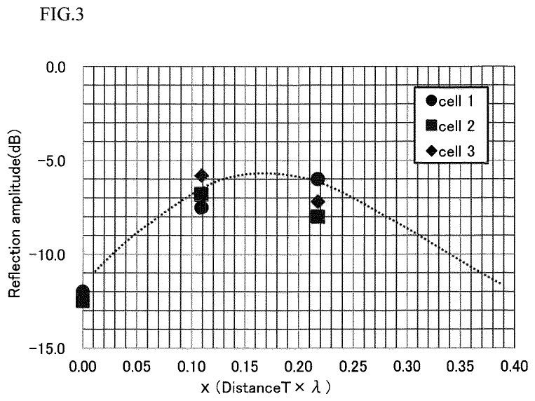

FIG. 3 shows results of the measured reflection amplitude versus distance T between the common electrode 110 and the metal film 116. Cells 1-3 with the configuration of the reflector unit cell 102 shown in FIG. 1B were used for the measurement results shown in FIG. 3. The patch electrode 108 and common electrode 110 of cells 1-3 were made of 1.0 μm thick aluminum (Al), and the metal film 116 was made of 1.0 μm thick aluminum (Al). The size of the patch electrode 108 was 2.80 mm square for Cell 1, 2.85 mm square for Cell 2, and 2.90 mm square for Cell 3, respectively. Glass substrates were used for substrates 104 and 106. The radio waves irradiated to the patch electrodes in Cells 1-3 were set to a wavelength (λ) of 10.7 mm in air at a frequency of 28 GHz.

The value obtained by multiplying the distance T between the common electrode 110 and the metal film 116 by the wavelength λ of the radio wave irradiated to the patch electrode 108 is x, the distance T×λ (distance T*λ).

Cells 1-3 were measured at x (distance T*λ)=0.00 (distance T=0.00 mm), 0.11 (distance T=0.50 mm), and 0.22 (distance T=1.00 mm) to measure the amplitude (dB) of the reflected wave, respectively. x=0 was measured using a reflection unit cell with no metal film 116 formed. The measurement of the reflection amplitude (amplitude of the reflected wave) was performed by a vector network analyzer (MS46522B, Anritsu).

From the graph in FIG. 3 and Table 1, it appears that the reflection amplitude varies as a function of x. The reflection amplitude should be greater than or equal to −10 dB. The reflection amplitude should be −10 dB or higher, and from the graph in FIG. 3 and Table 1, it appears that when x (distance T*λ) is 0.11 and 0.22, reflection amplitudes of −10 dB or higher are obtained in Cells 1 to 3. The curve fitting obtained from the measurement results (dotted line shown in FIG. 3) indicates that the x at which a reflection amplitude of −10 dB or more is obtained is between 0.02 and 0.34. Therefore, x should be equal to or greater than 0.02 and less than or equal to 0.34, and even more preferably equal to or greater than 0.10 and less than or equal to 0.22. By setting the distance T in such a range of x, the reflector unit cell 102 can further expand the amplitude of the reflected wave.

TABLE 1

| No. | x ( distance T * λ) | reflection amplitude (dB) |
|---|---|---|
| Cell 1 | 0.00 | −12.0 |
| | 0.11 | −7.5 |
| | 0.22 | −6.0 |
| Cell 2 | 0.00 | −12.5 |
| | 0.11 | −6.8 |
| | 0.22 | −8.0 |
| Cell 3 | 0.00 | −12.5 |
| | 0.11 | −5.8 |
| | 0.22 | −7.2 |

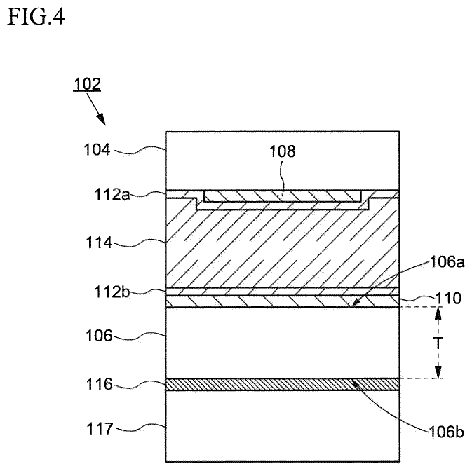

FIG. 4 shows an example of the substrate 117 with the metal film 116. Specifically, it shows an example where the substrate 117 is located on the side of the substrate 106 facing the substrate 104. The substrate 117 is provided with the metal film 116 and is bonded together so that the metal film 116 is arranged between the substrate 106 and the substrate 117. With this bonding, the distance T between the common electrode 110 on the substrate 106 and the metal film 116 on the substrate 117 becomes the thickness of the substrate 106. The substrate 117 can be prepared using the same substrates as the substrates 104 and 106.

Although FIG. 4 shows an example of the metal film 116 arranged on the substrate 117, radio wave reflectivity can be provided on the substrate 117. For example, a foil with radio wave reflectivity, such as aluminum or an aluminum alloy, can be used in place of the substrate 117 with the metal film 116.

Having this configuration in which the metal film 116 is located on the substrate 117, which is a different substrate from the substrate 106, allows the metal film 116 formation process to proceed simultaneously with the fabrication process of the reflector unit cell 102, thereby reducing the time required for fabrication of the reflector unit cell 102.

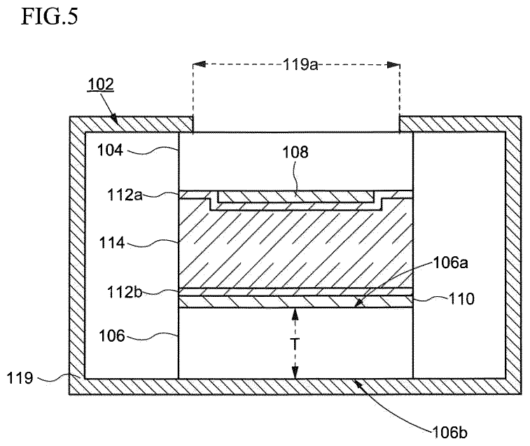

FIG. 5 shows an example in which the frame 119 holding the reflector unit cell 102 functions as the metal film 116. Specifically, the following is an example of the reflector unit cell 102 with a frame 119 made of a radio-reflective material facing the substrate 106.

As shown in FIG. 5, the frame 119 is arranged on the opposite side of the common electrode 110 from the liquid crystal layer 114 side so that it faces the substrate 106. The frame 119 also holds the substrate 104 and the substrate 106. The frame 119 is provided with an opening 119a through which radio waves irradiated by the patch electrode 108 and reflected by the common electrode 110 and the metal film 116 pass. The opening 119a has a width larger than the width of the patch electrode 108 in cross-sectional view in FIG. 5. Furthermore, if the frame 119 is used in the radio wave reflectors 100a and 100b described below, a plurality of reflector unit cells 102 may be used. However, instead of providing the opening 119a for each of the reflector unit cells 102, there should be one for a certain number of reflector unit cells 102, depending on the size of the radio wave reflector 100a or 100b. The number of apertures 119a is not limited.

As described above, the process of forming the metal film 116 can be omitted in the fabrication process of the radio wave reflector 100 by providing the frame 119 without the metal film 116. Also, an amplitude of reflected waves equal to or greater than that of the metal film 116 can be easily obtained by providing the frame 119 with a thickness greater than or equal to the thickness of the metal film 116.

According to the present embodiment, the amplitude of reflected waves in the reflector unit cell 102 can be expanded by having the liquid crystal layer 114 between the patch electrode 108 and the common electrode 110 and the metal film 116 arranged to overlap the patch electrode 108 on the side of the common electrode 110 facing the patch electrode 108. Consequently, the return loss (attenuation rate to irradiated radio waves) to radio waves irradiated to the patch electrode 108 can also be reduced. Thus, the reflection gain of the radio wave reflector 100 can be higher.

Furthermore, according to the present embodiment, the metal film 116 can be provided on the substrate 117 different from the substrate 106 on which the common electrode 110 is provided, or the frame 119 with radio wave reflective properties, by directly facing the metal film 116 or frame 119 to the substrate 106 so that the frame 119 can be retrofitted to the reflector unit cell 102. These retrofits can simplify and shorten the fabrication process of the reflector unit cell 102.

### 2. Reflecting Device

Next, the structure of the reflection array in which the reflector units are integrated is shown.

### 2-1. Reflecting Device a (Uniaxial Reflection Control)

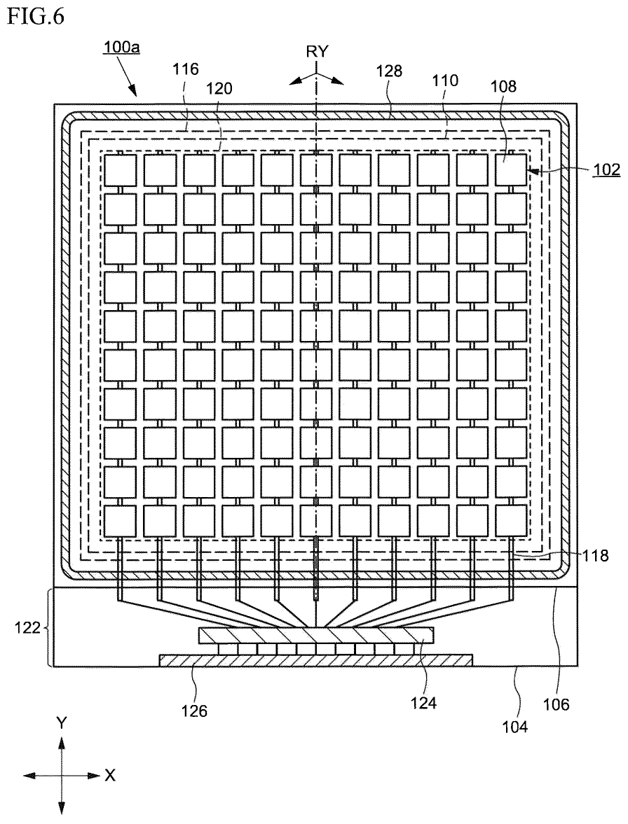

FIG. 6 shows a configuration of a reflecting device 100a according to an embodiment of the present invention. The reflecting device 100a includes a reflector 120. The reflector 120 is configured with a plurality of reflector unit cells 102. The plurality of reflector unit cells 102 are arranged, for example, in a first direction (X-axis direction shown in FIG. 6) and in a second direction (Y-axis direction shown in FIG. 6) that intersects the first direction. The plurality of reflector unit cells 102 are arranged so that the patch electrodes 108 face the plane of incidence of radio waves. The reflector 120 is flat, and the plurality of patch electrodes 108 are arranged in this flat plane in a matrix.

The reflecting device 100 has a structure in which the plurality of reflector unit cells 102 are integrated on a single substrate 104. As shown in FIG. 6, the reflecting device 100 has a structure in which a substrate 104 with an array of the plurality of patch electrodes 108 and the substrate 106 with the common electrode 110 and the metal film 116 are arranged on top of each other, and the liquid crystal layer (not shown) is disposed between the two substrates. In this case, the substrate 106 is oriented with the side where the common electrode 110 is provided toward the liquid crystal layer (not shown). The reflector 120 is formed in the region where the plurality of patch electrodes 108, the common electrode 110 and the metal film 116 are superimposed. A cross-sectional structure of the reflector 120 is the same as that of the reflector unit cell 102 shown in FIG. 1B when viewed with respect to the individual patch electrodes 108. In FIG. 6, although the metal film 116 is arranged inside the sealant 128, superimposed on the reflector 120 in a plan view, it may be provided wider than the reflector 120 or superimposed, or it may be provided so that it extends outside the sealant 128. The substrate 104 and the substrate 106 are bonded to each other by the sealant 128, and the liquid crystal layer, not shown, is disposed in the region inside the sealant 128.

Alternatively, it is possible to provide the frame 119 (not shown) without the metal film 116, as shown in FIG. 5. The frame 119 is provided so that the reflector 120 is exposed, and the opening 119a in the frame 119 is superimposed on the reflector 120. The frame 119, not shown, can be provided to protect and hold structures mounted on the radio reflector 100a. The frame 119, not shown, is arranged to surround the substrate 104 and the substrate 106 and to sandwich the substrate 104 and the substrate 106 in a cross-sectional view. The frame 119 can have one or more openings 119a depending on the size of the radio wave reflector 100a or the patch electrode 108.

The substrate 104 has a peripheral area 122 that extends outward from the substrate 106 in addition to the area that faces the substrate 106. The peripheral region 122 is disposed with a first driver circuit 124 and a terminal part 126. The first driver circuit 124 outputs control signals to the patch electrode 108. The terminal part 126 is a region that forms a connection with an external circuit, for example, a connected flexible printed circuit board, not shown. Signals controlling the first driver circuit 124 are input to the terminal part 126.

As described above, the plurality of patch electrodes 108 is arranged on the substrate 104 in the first (X-axis) and the second (Y-axis) directions. A plurality of first wirings 118 extending in the second direction (Y-axis direction) are arranged on the substrate 104. Each of the plurality of first wirings 118 is electrically connected to the plurality of patch electrodes 108 arranged in the second direction (Y-axis direction). In other words, the plurality of patch electrodes 108 arranged in the second direction (Y-axis direction) are connected by the first wiring 118. The reflector 120 has a configuration of a plurality of patch electrode arrays in a single row connected by the first wiring 118 in the first direction (X-axis direction).

The plurality of first wirings 118 arranged on the reflector 120 extend to the peripheral region 122 and are connected to the first driver circuit 124. The first driver circuit 124 outputs control signals to be applied to the patch electrode 108. The first driver circuit 124 can output control signals of different voltage levels to each of the plurality of first wirings 118. As a result, the control signal is applied to the plurality of patch electrodes 108 arranged in the first (X-axis) and second (Y-axis) directions in the reflector 120, row by row (for each patch electrode 108 arranged in the second direction (Y-axis)).

A control signal is applied to each pair of the plurality of patch electrodes 108 arranged in the second direction (Y-axis direction) in the reflecting device 100a. Thereby, the direction of reflection of the reflected wave of a radio wave incident on the reflector 120 can be controlled. That is, the reflecting device 100a can control the direction of travel of the reflected wave in the left and right directions on the drawing with respect to the reflection axis VR, which is parallel to the second direction (Y-axis direction), of the radio wave irradiated on the reflector 120.

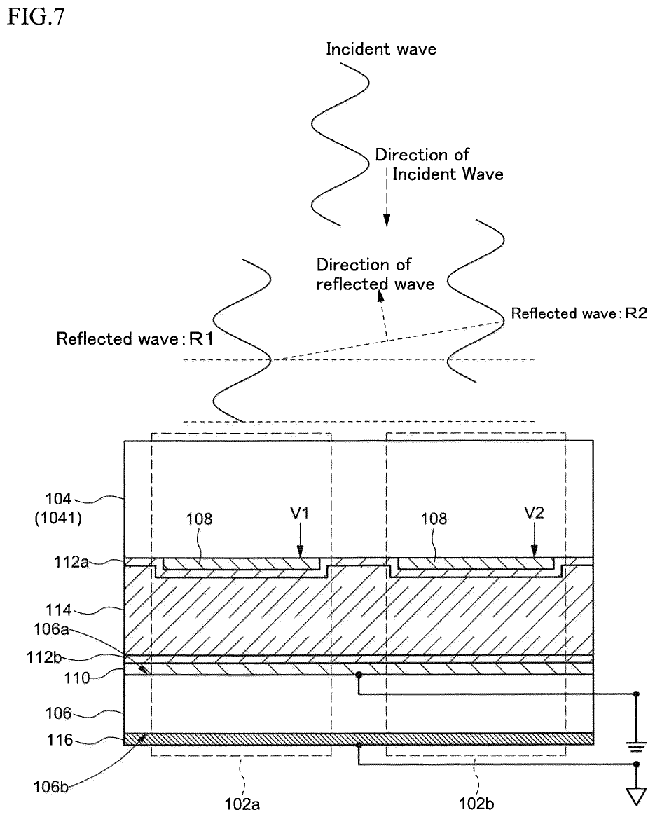

FIG. 7 schematically shows that the direction of travel of the reflected wave is changed by the two reflector unit cells 102. In the case where radio waves are incident on the first reflector unit cell 102a and the second reflector unit cell 102b at the same phase, since different control signals (V1≠V2) are applied to the first reflector unit cell 102a and the second reflector unit cell 102b, the phase change of the reflected wave by the second reflector unit cell 102b is larger than that of the first reflector unit cell 102a. As a result, the phase of the reflected wave R1 reflected by the first reflector unit cell 102a and the phase of the reflected wave R2 reflected by the second reflector unit cell 102b differ (in FIG. 7, the phase of the reflected wave R2 is more advanced than that of the reflected wave R1), and the apparent traveling direction of the reflected wave changes obliquely.

In FIG. 7, since the plurality of patch electrodes 108 arranged in the second direction (Y-axis direction) are electrically connected by the first wiring 118 and are electrically equipotential, it is also possible to replace it with a strip electrode continuous in the second direction (Y-axis direction) instead of a plurality of divided shapes. However, since the dimensions of the patch electrode 108 have an appropriate range depending on the wavelength of the reflected radio wave, if it is made into a strip electrode, the sensitivity for the target wavelength is reduced and the behavior towards the vertical polarization wave and horizontal polarization wave is different. Therefore, as shown in FIG. 7, it is preferable to arrange the patch electrodes 108 in an array having a shape that is symmetrical with respect to a vertical polarization wave and a horizontal polarization wave (FIG. 7 shows a square, but it may be circular) and to connect the plurality of patch electrodes 108 that are arranged parallel to the reflection axis RY by the first wiring 118.

### 2-2. Reflecting Device B (Biaxial Reflection Control)

Since the reflecting device 100a has a single reflection axis RY, the reflection angle can be controlled in the direction with the reflection axis RY as the axis of rotation. In contrast, this embodiment shows an example of a reflecting device 100b that is capable of biaxial reflection control. In the following description, the focus will be on the parts that differ from the reflecting device 100a.

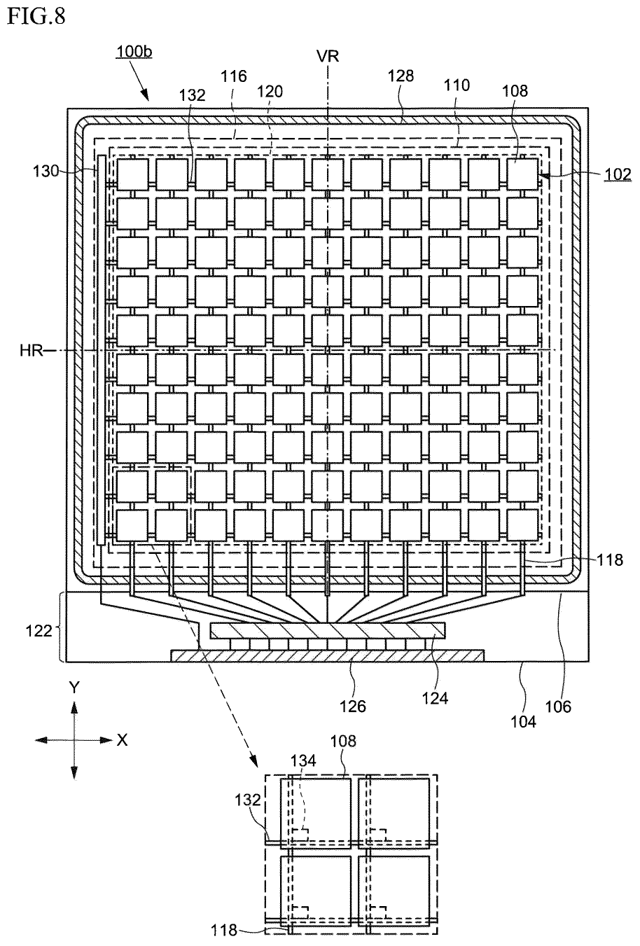

FIG. 8 shows the configuration of the reflecting device 100b. The following description will focus on the differences from the reflecting device 100a shown in FIG. 5.

The reflecting device 100b has a plurality of second wirings 132 extending in the first direction (X-axis direction) in addition to a plurality of first wirings 118 extending in the second direction (Y-axis direction) in the reflector 120. The plurality of first wirings 118 and the plurality of second wirings 132 are arranged to intersect across an insulating layer not shown in the diagram. The plurality of first wirings 118 are connected to a first driver circuit 124, and the plurality of second wirings 132 are connected to a second driver circuit 130. The first driver circuit 124 outputs control signals and the second driver circuit 130 outputs scanning signals.

FIG. 8 shows an enlarged inset of the arrangement of the four patch electrodes 108, the first wirings 118 and the second wirings 132. Each of the four patch electrodes 108 is disposed with a switching element 134. Switching (on and off) of the switching element 134 is controlled by the scanning signal applied to the second wiring 132. A control signal is applied from the first wiring 118 to the patch electrode 108 where the switching element 134 is turned on. The switching element 134 is formed, for example, by a thin-film transistor. According to this configuration, the plurality of patch electrodes 108 arranged in the first direction (X-axis direction) can be selected row by row, and control signals of different voltage levels can be applied to each row.

The reflecting device 100b shown in FIG. 8 can control the direction of travel of the reflected wave in the left and right directions on the drawing, centered on the reflection axis VR parallel to the second direction (Y-axis direction), when the radio wave is irradiated on the reflector 120, furthermore, the direction of travel of the reflected wave can also be controlled in the vertical direction on the drawing, centered on the reflection axis HR parallel to the first direction (X-axis direction). That is, since the reflecting device 100b has the reflection axis VR parallel to the second direction (Y-axis direction) and the reflection axis VH parallel to the first direction (X-axis direction), the reflection angle can be controlled in the direction with the reflection axis VR as the axis of rotation and in the direction with the reflection axis HR as the axis of rotation.

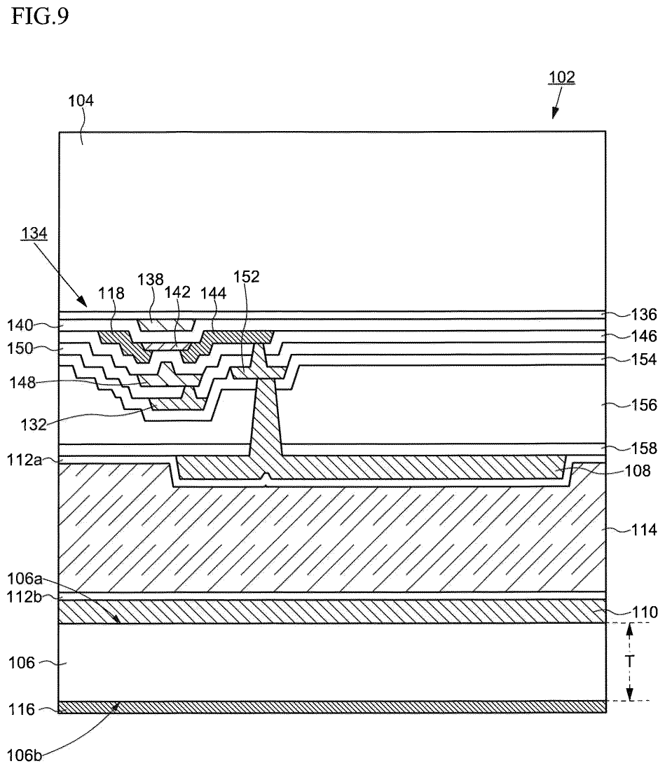

FIG. 9 shows an example of the cross-sectional structure of the reflector unit cell 102 with the switching element 134 connected to the patch electrode 108. The switching element 134 is disposed on the substrate 104. The switching element 134 is a transistor and has a stacked structure of a first gate electrode 138, a first gate insulation layer 140, a semiconductor layer 142, a second gate insulation layer 146, and a second gate electrode 148. An undercoat layer 136 may be disposed between the first gate electrode 138 and the substrate 104. The first wiring 118 is disposed between the first gate insulating layer 140 and the second gate insulating layer 146. The first wiring 118 is disposed in contact with the semiconductor layer 142. A first connecting wiring 144 is disposed on the same layer as the conductive layer forming the first wiring 118. The first connecting wiring 144 is disposed in contact with the semiconductor layer 142. The connection structure of the first wiring 118 and the first connecting wiring 144 to the semiconductor layer 142 shows a structure in which one wiring is connected to the source of the transistor and the other wiring is connected to the drain.

A first interlayer insulating layer 150 is disposed to cover the switching element 134. The second wiring 132 is disposed on the first interlayer insulating layer 150. The second wiring 132 is connected to the second gate electrode 148 through a contact hole formed in the first interlayer insulation layer 150. Although not shown in the figure, the first gate electrode 138 and the second gate electrode 148 are electrically connected to each other in a region that does not overlap the semiconductor layer 142. A second connecting wiring 152 is disposed on the first interlayer insulating layer 150 with the same conductive layer as the second wiring 132. The second connecting wiring 152 is connected to the first connecting wiring 144 through a contact hole formed in the first interlayer insulating layer 150.

A second interlayer insulating layer 154 is disposed to cover the second wiring 132 and the second connecting wiring 152. Furthermore, a planarization layer 156 is disposed to fill the steps of the switching element 134. It is possible to form the patch electrode 108 without being affected by the arrangement of the switching element 134 by arranging the planarization layer 156. A passivation layer 158 is disposed over the flat surface of the planarization layer 156. The patch electrode 108 is disposed over the passivation layer 158. The patch electrode 108 is connected to the second connecting wiring 152 through a contact hole formed through the passivation layer 158, the planarization layer 156, and the second interlayer dielectric layer 154. The first alignment film 112a is disposed over the patch electrode 108.

The substrate 106 is provided with the common electrode 110, the metal film 116 on the second surface that is opposite to the first surface 106a where the common electrode 110 is provided, and the second alignment film 112b, as in FIG. 1B. The distance T between the common electrode 110 and the metal film 116 can be the thickness of the substrate 106. The surface on which the switching element 134 and the patch electrode 108 of the substrate 104 are provided is arranged so that the surface on which the common electrode 110 of the substrate 106 is provided faces the surface switching element 134, and the liquid crystal layer 114 is provided between them.

Each layer formed on the substrate 104 is formed using the following materials. The undercoat layer 136 is formed, for example, with a silicon oxide film. The first gate insulating layer 140 and the second gate insulating layer 146 are formed, for example, with a silicon oxide film or a laminated structure of a silicon oxide film and a silicon nitride film. The semiconductor layers are formed of silicon semiconductors such as amorphous silicon and polycrystalline silicon, and oxide semiconductors including metal oxides such as indium oxide, zinc oxide, and gallium oxide. The first gate electrode 138 and the second gate electrode 148 may be configured, for example, of molybdenum (Mo), tungsten (W), or alloys thereof. The first wiring 118, the second wiring 132, the first connecting wiring 144, and the second connecting wiring 152 are formed using metal materials such as titanium (Ti), aluminum (Al), and molybdenum (Mo). For example, a titanium (Ti)/aluminum (Al)/titanium (Ti) laminate structure or a molybdenum (Mo)/aluminum (Al)/molybdenum (Mo) laminate structure may be used. The planarization layer 156 is formed of a resin material such as acrylic, polyimide, or the like. The passivation layer 158 is formed of, for example, a silicon nitride film. The patch electrode 108 and the common electrode 110 are formed of a metal film such as aluminum (Al), copper (Cu), or a transparent conductive film such as indium tin oxide (ITO).

As shown in FIG. 8, it is possible to select a predetermined patch electrode from the plurality of patch electrodes 108 arranged in a matrix and apply a control signal to the patch electrode, by connecting the second wiring 132 to the gate of the transistor used as the switching element 134, the first wiring 118 to one of the source and drain of the transistor, and the patch electrode 108 to the other of the source and drain. Then, it is possible to apply a control voltage to each patch electrode 108 arranged in a row along the first direction (x-axis direction) or each patch electrode 108 arranged in a row along the second direction (y-axis direction), by arranging the switching element 134 for each individual patch electrode 108 in the reflector 120, for example, when the reflector 120 is upright, the direction of reflection of the reflected wave can be controlled in the left-right and vertical directions.

As described above, the radio wave reflector 100 of one embodiment of the invention has the metal film 116 formed on the opposite side of the common electrode 110 from the liquid crystal layer side that forms the reflector 120, and the distance T between the common electrode 110 and the metal film 116 thereof multiplied by the wavelength λ of the radio wave irradiated to the patch electrode 108 is equal to or greater than 0.02 and less than or equal to 0.34 or equal to or greater than 0.10 and less than or equal to 0.22, thus allowing the reflection gain to be higher.

The various configurations of the reflecting device and reflector unit cells illustrated as embodiments of the present invention can be combined as appropriate as long as they do not contradict each other. Based on the reflecting device and reflector unit cell disclosed in this specification and the drawings, any addition, deletion, or design change of configuration elements, or any addition, omission, or change of conditions of a process by a person skilled in the art as appropriate, are also included in the scope of the present invention as long as they have the gist of the invention.

It is understood that other advantageous effects different from the advantageous effects disposed by the embodiments disclosed herein, which are obvious from the description herein or which can be easily foreseen by a person skilled in the art, will naturally be disposed by the present invention.

What is claimed is:

1. A reflecting device, comprising:
a patch electrode;
a common electrode;
a liquid crystal layer sandwiched between the patch electrode and the common electrode; and
a metal film arranged on the opposite side of the common electrode from the side of the liquid crystal layer,
wherein the metal film is spaced apart from the common electrode, and
the patch electrode is arranged to overlap the metal film.

2. The reflecting device according to claim 1,
wherein x is the value obtained by multiplying a distance T between the common electrode and the metal film by the wavelength λ of the radio wave irradiated to the patch electrode, and
x is equal to or greater than 0.02 and less than or equal to 0.34.

3. The reflecting device according to claim 2,
wherein x is equal to or greater than 0.10 and less than or equal to 0.22.

4. The reflecting device according to claim 1,
wherein the common electrode is applied with a ground potential, and
the metal film is in a floating state.

5. The reflecting device according to claim 1, further comprising,
a substrate,
wherein the common electrode is located on a first surface of the substrate,
the metal film is located on a second surface opposite the first surface of the substrate, and
the substrate has the equivalent thickness as the distance T.

6. The reflecting device according to claim 1, wherein the liquid crystal layer is sandwiched between the patch electrode and the common electrode.

7. A reflecting device comprising,
a patch electrode;
a common electrode;
a liquid crystal layer sandwiched between the patch electrode and the common electrode;
a first substrate; and
a metal film on the first substrate,
wherein the metal film is arranged on a side of the common electrode facing the patch electrode, and
the patch electrode is arranged to overlap the metal film.

8. The reflecting device according to claim 7,
wherein x is the value obtained by multiplying a distance T between the common electrode and the metal film by the wavelength λ of the radio wave irradiated to the patch electrode, and
x is equal to or greater than 0.02 and less than or equal to 0.34.

9. The reflecting device according to claim 7,
wherein x is equal to or greater than 0.10 and less than or equal to 0.22.

10. The reflecting device according to claim 7,
wherein the common electrode is applied a with a ground potential, and
the metal film is in a floating state.

11. The reflecting device according to claim 8, further comprising,
a second substrate,
wherein the second substrate is arranged between the common electrode and the metal film, and
the second substrate has the equivalent thickness as the distance T.
